(19) United States
(12) Patent Application Publication
(10) Pub. No.: US 2001/0035248 A1
(43) Pub. Date: Nov. 1, 2001

(54) Fiberboard splice apparatus, corrugate machine, and fiberboard splice method

(75) Inventors: Hiroshi Sato, Hiroshima-ken (JP); Hiroaki Sasashige, Hiroshima-ken (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Mitsubishi Heavy Industries, Ltd., Tokyo (JP)

(21) Appl. No.: 09/805,197

(22) Filed: Mar. 14, 2001

(30) Foreign Application Priority Data
Apr. 27, 2000 (JP) 2000-128524
Aug. 11, 2000 (JP) 2000-245166

(51) Int. Cl. B65H 69/06; B32B 31/00

(52) U.S. Cl. 156/64; 156/157; 156/364; 156/494

(57) ABSTRACT

A fiberboard splice apparatus is capable of fully automating preparatory works for a fiberboard splice process to shorten the time needed for the preparation and to enhance the machine availability factor, and is made up of a fiberboard splice part for adhering an old fiberboard fed from one roll fiberboard to an end portion of a new fiberboard fed from the other roll fiberboard to accomplish fiberboard splice therebetween and a fiberboard feed device placed between the fiberboard splice part and the other roll fiberboard for feeding the new fiberboard to the fiberboard splice part. The fiberboard feed device comprises a fiberboard feed roll located along an axial direction of the other roll fiberboard for rotating the other roll fiberboard while coming into contact with the other roll fiberboard, a pickup member for picking up the end portion of the other roll fiberboard while coming into sliding contact with a surface of the other roll fiberboard, and a guide member for guiding the end portion of the other roll fiberboard picked up by the pickup member to the fiberboard splice part.

### BACKGROUND OF THE INVENTION

(1) Field of the Invention

The present invention relates to a fiberboard (fibreboard) splice apparatus, a corrugate machine including this fiberboard splice apparatus, and a fiberboard splice method, and more particularly to a fiberboard splice apparatus, a corrugate machine including this fiberboard splice apparatus, and a fiberboard splice method, which are suitable for automization of a preparatory process for fiberboard splice.

(2) Description of Related Art

FIG. 13 is an illustration of a mechanical configuration of a single facer part of a corrugate machine for production of a corrugated fiberboard sheet.

As FIG. 13 shows, mill roll stands 2 for respectively rewinding and supplying roll fiberboards (rolled base paper) 3 and 4 are located before and after a single facer 1 [that is, on the upstream and downstream sides in a sheet conveying direction (sheet advancing direction)]. The roll fiberboard 3 is paper put presently in use for production, while the roll fiberboard 4 is paper placed in a stand-by condition to be fed immediately to the single facer 1 in place of the roll fiberboard 3 in the case of an exhaustion of the roll fiberboard or a fiberboard replacement involved in an order change. At the replacement (interchange) of the roll fiberboard 3 with the roll fiberboard 4, a fiberboard splice apparatus 6 joints or connects the front end (tip) portion of a new fiberboard (fiberboard to be supplied from the roll fiberboard 4) to the rear end portion of the old fiberboard (fiberboard to be fed from the roll fiberboard 3) in an overlapped condition.

Secondly a description will be given hereinbelow of the outline of the fiberboard splice apparatus 6.

As FIG. 13 shows, the fiberboard splice apparatus 6 is located on a bridge 5 installed to extend above the mill roll stands 2 and the single facer 1. In this fiberboard splice apparatus 6, a fiberboard splice unit 10 is situated to be movable in front-to-back directions. That is, the fiberboard splice unit 10 is placed to be movable from the upstream side to the downstream side in the sheet advancing direction (machine direction). In general, in the splice works, the fiberboard splice unit 10 is positioned above the new fiberboard (in this case, the fiberboard to be supplied from the roll fiberboard 4). Incidentally, although a dancer roll and others are incorporated into the fiberboard splice apparatus 6, they are omitted from the illustration.

In addition, referring to FIG. 14, a detailed description will be given hereinbelow of the fiberboard splice unit 10.

As FIG. 14 shows, guide rolls 12 and 13 are set on both side frames 11 of the fiberboard splice unit 10 extending in a sheet cross direction. On an inner side of the frame 11, there is set a frame 14 made to rock around an axis X of the guide roller 12, and to this frame 14, there are attached a fixed stop bar 16, a movable stop bar 17, a pressing bar 18 and a knife 19. These will collectively be referred to hereinafter as a fiberboard splice part 15 (15a, 15b). Additionally, a suction device (not shown) is built in the pressing bar 18 to provide a function to suck and hold the new fiberboard forwarded from the roll fiberboard 4 (or the roll fiberboard 3).

As FIG. 14 shows, as this fiberboard splice part 15, two sets of fiberboard splice parts 15a and 15b are located symmetrically in conjunction with the old fiberboard feeding roll fiberboard 3 and the new fiberboard feeding roll fiberboard 4, respectively. In this illustration, the old fiberboard 3 travels through one fiberboard splice part 15a while the new fiberboard 4 is in the stand-by condition on the other fiberboard splice part 15b. Additionally, a pressure sensitive adhesive double coated tape 20 is adhered onto the tip portion of the new fiberboard 4. Incidentally, the same reference marks are used for both the roll fiberboard and the fiberboard fed from the roll fiberboard.

Furthermore, a brief description will be given hereinbelow of the fiberboard splice process.

First of all, in response to a fiberboard splice command, the movable stop bar 17 is shifted to hold the old fiberboard 3 together with the fixed stop bar 16 to stop the traveling of the old fiber board 3. Following this, both the fiberboard splice parts 15a and 15b are rotated to cause the pressing bars 18 and 18 to approach each other and finally come into contact with each other so that the adhesion between the new and old fiberboards 3 and 4 takes place through the use of the pressure sensitive adhesive double coated tape 20. Then, the knife 19 is actuated to cut the old fiberboard 3. Thereafter, acceleration rolls 21, 21 make the roll fiberboards 3 and 4, being in a stopping state after the fiberboard splice, travel while accelerated, thus returning to the ordinary operating condition.

Although the above description involves the fiberboard splice process after the pressure sensitive adhesive double coated tape 20 is attached onto the front end portion of the new fiberboard 4 in a state where the new fiberboard 4 is held on the pressing bar 18, a preparatory process is necessary before this state.

This preparatory process will be described hereinbelow with reference to FIGS. 15A to 15D.

First of all, as shown in FIG. 15A, a new roll fiberboard (roll fiberboard for feeding a new fiberboard) 4 is put on a fiberboard supply carriage 7 to be carried into a predetermined position between arms 2a and 2a of a mill roll stand 2. The front end portion of the new roll fiberboard 4 is fixed with a tape 8 to prevent the new roll fiberboard 4 from betting loose during conveyance.

Secondly, as shown in FIG. 15B, when the new roll fiberboard 4 has been carried into the predetermined position, the arms 2a and 2a of the mill roll stand 2 chuck the new roll fiberboard 4 with their end portions and lifts the new roll fiberboard 4 so that it can be drawn out as a web.

Following this, an operator peels the tape 8 or cuts it, and then, as shown in FIG. 15C, the new roll fiberboard 4 is introduced through a predetermined roll into the fiberboard splice unit 10 while being pulled at its tip portion thereof.

In this case, for easy preparatory work, the fiberboard splice part 15 of the fiberboard splice unit 10 is pushed down to a position indicated by a two-dot chain line in FIG. 14. In this connection, the position indicated by a solid line in FIG. 14 is referred to as a “stand-by position”, while the position indicated by the two-dot chain line in the illustration is called the “preparatory position”.

Furthermore, as shown in FIG. 15D, the new roll fiberboard 4 introduced into the fiberboard splice part 15 is guided through the guide roll 12, the fixed stop bar 16, the knife 19 and the pressing bar 18, and the tip portion thereof is cut to remove the fiberboard of a predetermined appropriate length (for example, approximately one turn of the fiberboard roll). The cut tip portion is held by the pressing bar 18 and the pressure sensitive adhesive double coated tape 20 is adhered onto a surface thereof. Thereafter, as indicated by the solid line in FIG. 14, the frame 14 is rotated up to the normal stand-by position, at which the preparation (setup) for the fiberboard splice process reaches completion.

In this case, the tip portion of the new roll fiberboard 4, for example, corresponding to approximately one turn of the roll fiberboard 4, is abandoned. This is because, when the tape 8 is peeled or cut, the new roll fiberboard 4 can get torn at the position corresponding to one turn of the fiberboard or a portion of the tape 8 can be left. In addition, for example, during the storage, a surface of the fiberboard can get torn or its moisture can vary abnormally, and in such a case, the fiberboard may be cut to remove the fiberboard of a length corresponding to more-than one turn.

Meanwhile, in the above-mentioned preparation for the fiberboard splice, an operator manually conducts the following operations: that is, after the new roll fiberboard 4 is chucked by the mill roll stand 2, not only the tape is peeled but also the tip portion of the new fiberboard 4 fed from the new roll fiberboard 4 is forwarded to run over the pressing bar 18 and is cut and even the pressure sensitive adhesive double coated tape 20 is attached onto the cut portion.

However, since such manual operations take time in the preparatory stage for the fiberboard splice process, difficulty is experienced in enhancing the machine availability factor. Particularly, for example, in a case in which the replacement of roll fiberboards is frequent according to various orders, the improvement of the machine availability factor becomes difficult and a large burden is imposed on the operator.

### SUMMARY OF THE INVENTION

The present invention has been developed in view of the above-mentioned problems, and it is therefore an object of the invention to provide a fiberboard splice apparatus, a corrugate machine equipped with this fiberboard splice apparatus, and a fiberboard splice method, which are capable of shortening the time to be taken for the preparation through the full automization of preparatory works for the fiberboard splice to enhance the machine availability factor.

For this purpose, a fiberboard splice apparatus according to the present invention comprises a fiberboard splice part for adhering an old fiberboard fed from one roll fiberboard to an end portion of a new fiberboard fed from the other roll fiberboard to accomplish fiberboard splice therebetween and a fiberboard feed device located between the fiberboard splice part and the other roll fiberboard for forwarding the new fiberboard to the fiberboard splice part, the fiberboard feed device including a fiberboard feed roll placed along an axial direction of the other roll fiberboard for rotating the other roll fiberboard while coming into contact with a surface of the other roll fiberboard, a pickup (catch) member for picking up an end portion of the other roll fiberboard while coming into sliding contact with a surface of the other roll fiberboard, and a guide member for guiding the end portion of the other roll fiberboard picked up by the pickup member to the fiberboard splice part.

Preferably, the fiberboard feed device is equipped with a pair of fiberboard feed rolls serving as the fiberboard feed roll and a pair of pickup members serving as the pickup member, and further provided with a pair of roll supporting frames for supporting the pair of fiberboard feed rolls at their end portions, a bar-like member placed along the axial directions of the pair of fiberboard feed rolls to stretch (span) between the pair of roll supporting frames, and a pickup member supporting member attached to the bar-like member for supporting the pair of pickup members so that the pair of pickup members are in opposed relation to the pair of fiberboard feed rolls, respectively, if the other roll fiberboard is in a face-winding condition in which a fiberboard is formed in a state where its fiberboard face constitutes an outer surface, the bar-like member is rotated to bring a surface of one fiberboard feed roll and a tip portion of one pickup member into contact with a surface of the other roll fiberboard while, if the other roll fiberboard is in a back-winding condition in which a fiberboard is wound in a state where its fiberboard back constitutes an outer surface, the bar-like member is rotated to bring a surface of the other fiberboard feed roll and a tip portion of the other pickup member into contact with a surface of the other roll fiberboard.

Furthermore, preferably, the fiberboard feed device is equipped with a pair of fiberboard feed rolls serving as the fiberboard feed roll, a pair of pickup members serving as the pickup member and a movable guide member serving as the guide member which is touchable and separable on and from a surface of the one fiberboard feed roll of the pair of fiberboard feed rolls, and further provided with a pair of roll supporting frames for supporting the pair of fiberboard feed rolls at their end portions, a bar-like member located along the axial directions of the pair of fiberboard feed rolls to stretch between the pair of roll supporting frames, and a pickup member supporting member attached to the bar-like member for supporting the pair of pickup members so that the pair of pickup members are in opposed relation to the pair of fiberboard feed rolls, respectively, and if the bar-like member is rotated so that the fiberboard feed device takes a first position at which the other fiberboard feed roll and the one pickup member are touchable on a surface of the other roll fiberboard, the movable guide member is placed at a position separated from a surface of the one fiberboard feed roll, and the new fiberboard is guided through a fiberboard feed passage extending from a portion between the one pickup member and the other fiberboard feed roll to the fiberboard splice part along the guide member, while if the bar-like member is rotated so that the fiberboard feed device takes a second position at which the one fiberboard feed roll and the other pickup member are touchable on a surface of the other roll fiberboard, the movable guide member is moved in a direction of approaching a surface of the one fiberboard feed roll to hold an end portion of the new fiberboard led through a space between the other pickup member and the one fiberboard feed roll, and in this state, the bar-like member is rotated to shift the fiberboard feed device to the first position and the new fiberboard is guided through the fiberboard feed passage.

Still furthermore, preferably, a tip portion of the other roll fiberboard is adhered onto an outer surface of the other roll fiberboard through the use of a tape, and the fiberboard splice apparatus further comprises a tape detection sensor for sensing the presence of the tape, a fiberboard feed roll actuator for rotating the fiberboard feed roll and control means for issuing a control signal to operate the fiberboard feed roll actuator, with the control means drives the fiberboard feed roll actuator to set a rotating speed of the fiberboard feed roll at a value below a predetermined rotating speed when the tape detection sensor senses the presence of the tape.

In addition, preferably, a tip portion of the other roll fiberboard is adhered onto an outer surface of the other roll fiberboard through the use of a tape and the pickup member is a finger having a function to cut the tape, and the fiberboard splice apparatus further comprises a fiberboard detection sensor for sensing the other roll fiberboard picked up by the finger, a finger actuator for shifting the finger in an axial direction of the other roll fiberboard, a fiberboard feed roll actuator for rotating the fiberboard feed roll, and control means for issuing a control signal for operating each of the finger actuator and the fiberboard feed roll actuator, with the control means, when the fiberboard detection sensor senses the other roll fiberboard, issuing a signal to the fiberboard feed roll actuator for stopping the rotation of the fiberboard feed roll and further issuing a signal to the finger actuator to shift the finger in the axial direction of the other roll fiberboard for cutting the tape.

Still additionally, preferably, a tip portion of the other roll fiberboard is adhered onto an outer surface of the other roll fiberboard through the use of a tape and the pickup member is a peeling nail (claw) having a function to peel the tape, and the fiberboard splice apparatus further comprises a fiberboard detection sensor for sensing the other roll fiberboard picked up by the peeling nail, a peeling nail actuator for shifting the peeling nail in an axial direction of the other roll fiberboard, a fiberboard feed roll actuator for rotating the fiberboard feed roll and control means for issuing a control signal to operate each of the peel nail actuator and the fiberboard feed roll actuator, with the control means, when the fiberboard detection sensor senses the other roll fiberboard, issuing a signal to the fiberboard feed roll actuator for stopping the rotation of the fiberboard feed roll and further issuing a signal to the peel nail actuator for shifting the peel nail to under the tape, and issuing a signal to the fiberboard feed roll actuator for rotating the fiberboard feed roll in the reverse direction to peel the tape in a state where the peel nail is positioned under the tape.

Moreover, preferably, a fiberboard end processing device is provided to cut the new fiberboard, fed by the fiberboard feed device, at a predetermined length from its tip portion.

Still moreover, it is also acceptable that a tape adhering device is provided to adhere a pressure sensitive adhesive double coated tape onto an end portion of the new fiberboard.

A fiberboard splice apparatus according to the present invention comprises a fiberboard splice part for adhering an old fiberboard fed from one roll fiberboard to an end portion of a new fiberboard fed from the other roll fiberboard to accomplish fiberboard splice therebetween, a fiberboard feed device, which is located between the fiberboard splice part and the other roll fiberboard, for feeding the new fiberboard into the fiberboard splice part, a roll stand equipped with an arm for supporting the other roll fiberboard, and a fiberboard splice unit moving device for moving the fiberboard splice unit to a position facing the other roll fiberboard supported by the arm, with the fiberboard splice unit moving device adjusting a position of the fiberboard splice unit in accordance with an arm angle of the roll stand.

A corrugate machine according to the present invention includes a fiberboard splice apparatus with the above-mentioned construction.

In accordance with the present invention, there is provided a fiberboard splice method of adhering an old fiberboard fed from one roll fiberboard to an end portion of a new fiberboard fed from the other roll fiberboard for accomplishing fiberboard splice therebetween, the method comprising the steps of rotating the other roll fiberboard by a fiberboard feed roll located along an axial direction of the other roll fiberboard and brought into contact with a surface of the other roll fiberboard, picking up an end portion of the other roll fiberboard through the use of a pickup member brought into sliding contact with a surface of the other roll fiberboard, and guiding, through the use of a guide member, the end portion of the other roll fiberboard, picked up by the pickup member, to the fiberboard splice part in which the end portion of the new fiberboard is adhered onto the old fiberboard for the fiberboard splice.

Preferably, the fiberboard splice method uses a pair of fiberboard feed rolls as the fiberboard feed roll and a pair of pickup members as the pickup member, and the method further uses a pair of roll supporting frames for supporting the pair of fiberboard feed rolls at their end portions, a bar-like member placed along the axial directions of the pair of fiberboard feed rolls to stretch between the pair of roll supporting frames, and a pickup member supporting member attached to the bar-like member for supporting the pair of pickup members so that the pair of pickup members are in opposed relation to the pair of fiberboard feed rolls, respectively, and the method further comprises the step of, if the other roll fiberboard is in a face-winding condition in which a fiberboard is wound in a state where its fiberboard face constitutes an outer surface, rotating the bar-like member for bringing a surface of one fiberboard feed roll and a tip portion of one pickup member into contact with a surface of the other roll fiberboard while, if the other roll fiberboard is in a back-winding condition in which a fiberboard is wound in a state where its fiberboard back constitutes an outer surface, rotating the bar-like member for bringing a surface of the other fiberboard feed roll and a tip portion of the other pickup member into contact with a surface of the roll fiberboard.

Furthermore, preferably, the fiberboard splice method uses a pair of fiberboard feed rolls as the fiberboard feed roll, a pair of pickup members as the pickup member and a movable guide member, touchable and separable on and from a surface of the one fiberboard feed roll, as the guide member, and the method further uses a pair of roll supporting frames for supporting the pair of fiberboard feed rolls at their end portions, a bar-like member located along axial directions of the pair of fiberboard feed rolls to stretch between the pair of roll supporting frames, and a pickup member supporting member attached to the bar-like member to support the pair of pickup members so that the pair of pickup members are in opposed relation to the pair of fiberboard feed rolls, respectively, and the method further comprises the step of, if the bar-like member is rotated so that taken is a first position at which the other fiberboard feed roll and the one pickup member are touchable on a surface of the other roll fiberboard, placing the movable guide member at a position separated from a surface of the one fiberboard feed roll for guiding the new fiberboard through a fiberboard feed passage, extending from a portion between the one pickup member and the other fiberboard feed roll, to the fiberboard splice part along the movable guide member, while, if the bar-like member is rotated so that taken is a second position at which the one fiberboard feed roll and the other pickup member are touchable on a surface of the other roll fiberboard, moving the movable guide member in a direction of approaching a surface of the one fiberboard feed roll for holding an end portion of the new fiberboard led through a space between the other pickup member and the one fiberboard feed roll, and in this state, rotating the bar-like member so that the first position is taken to guide the new fiberboard through the fiberboard feed passage.

Still furthermore, preferably, the fiberboard splice method further comprises the step of, in a case in which a tip portion of the other roll fiberboard is adhered onto an outer surface of the other roll fiberboard through the use of a tape, when the presence of the tape is sensed by a tape detection sensor, driving a fiberboard feed roll actuator in accordance with a signal from control means to set a rotating speed of the fiberboard feed roll at a value below a predetermined rotating speed.

In addition, preferably, in a case in which a tip portion of the other roll fiberboard is adhered onto an outer surface of the other roll fiberboard through the use of a tape, the fiberboard splice method uses, as the pickup member, a finger having a function to cut the tape, and the method further comprises the steps of, when the other roll fiberboard picked up by the finger is sensed by a fiberboard detection sensor, driving a fiberboard feed roll actuator in accordance with a signal from control means for stopping the rotation of the fiberboard feed roll, and driving a finger actuator in accordance with a signal from the control means for shifting the finger in an axial direction of the other roll fiberboard to cut the tape.

Still additionally, preferably, in a case in which a tip portion of the other roll fiberboard is adhered onto an outer surface of the other roll fiberboard through the use of a tape, and the fiberboard splice method uses, as the pickup member, a peeling nail having a function to peel the tape, and the method further comprises the steps of, when the other roll fiberboard picked up by the peeling nail is sensed by a fiberboard detection sensor, driving a peeling nail actuator in accordance with a signal from control means for stopping the rotation of the fiberboard feed roll, and driving a peeling nail actuator in accordance with a signal from the control means for shifting the peeling nail in an axial direction of the other roll fiberboard to peel the tape.

Moreover, in the fiberboard splice method, it is preferable that the new fiberboard fed from the other roll fiberboard is cut at a position corresponding to a predetermined length from its tip portion.

Still moreover, it is also acceptable to adhere a pressure sensitive adhesive double coated tape onto an end portion of the new fiberboard.

A fiberboard splice method according to the present invention uses, for fiberboard splice, a fiberboard splice part for adhering an old fiberboard fed from one roll fiberboard to an end portion of a new fiberboard fed from the other roll fiberboard supported by an arm of a roll stand and a fiberboard splice unit located between the fiberboard splice part and the other roll fiberboard and equipped with a fiberboard feed device for feeding the new fiberboard into the fiberboard splice part, the method comprising the step of moving the fiberboard splice unit on the basis of an arm angle of the roll stand so that the fiberboard splice unit is positioned at a position facing the other roll fiberboard.

Accordingly, with a fiberboard splice apparatus, a corrugate machine including this fiberboard splice apparatus and a fiberboard splice method according to the present invention, the full automization of the preparatory operations for the fiberboard splice process becomes feasible, which can shorten the time needed for the preparation to enhance the machine availability factor.

### BRIEF DESCRIPTION OF THE DRAWINGS

FIG. 1 illustratively shows the entire construction of a fiberboard splice apparatus included in a corrugate machine according to an embodiment of the present invention;

FIG. 2 is a cross-sectional view illustratively showing a fiberboard splice unit of the fiberboard splice apparatus according to the embodiment of the invention;

FIG. 3 is an enlarged view illustratively showing a fiberboard feed device included in the fiberboard splice apparatus according to the embodiment of the invention, with the fiberboard feed device being at the location indicated by an arrow A in FIG. 2;

FIG. 4 is an illustrative view useful for describing a finger included in the fiberboard splice apparatus according to the embodiment of the invention;

FIG. 5 is an enlarged view illustratively showing the fiberboard feed device included in the fiberboard splice apparatus according to the embodiment of the invention, and is for describing a case in which a roll fiberboard is in the reverse winding condition with respect to that in FIG. 3;

FIG. 6 is an illustrative view useful for describing a tape adhering device included in the fiberboard splice apparatus according to the embodiment of the invention, and is taken along the line C-C of FIG. 2;

FIG. 7 is an illustrative view useful for describing a fiberboard end processing device included in the fiberboard splice apparatus according to the embodiment of the invention, and is taken along the line D-D of FIG. 2;

FIG. 8A is an illustrative view useful for describing fiberboard end processing by the fiberboard end processing device included in the fiberboard splice apparatus according to the embodiment of the invention, and shows a case in which the length of a fiberboard to be cut away is relatively short;

FIG. 8B is an illustrative view useful for describing fiberboard end processing by the fiberboard end processing device included in the fiberboard splice apparatus according to the embodiment of the invention, and shows a case in which the length of a fiberboard to be cut away is somewhat long;

FIG. 8C is an illustrative view useful for describing fiberboard end processing by the fiberboard end processing device included in the fiberboard splice apparatus according to the embodiment of the invention, and shows a case in which the length of a fiberboard to be cut away is relatively long;

FIG. 9 is an enlarged view illustratively showing the fiberboard splice apparatus according to the embodiment of the invention, and is for explaining a case in which a roll fiberboard is in the reverse winding condition;

FIG. 10 is an illustrative perspective view useful for explaining disadvantageous points in a case in which a tape is cut through the use of the finger of the fiberboard splice apparatus according to the embodiment of the invention;

FIG. 11A is a plan view illustratively showing a peeling nail forming a first modification of a pickup member of the fiberboard splice apparatus according to the embodiment of the invention;

FIG. 11B is a plan view illustratively showing the peeling nail forming the first modification of the pickup member of the fiberboard splice apparatus according to the embodiment of the invention, and showing a state where the peeling nail is positioned under a roll fiberboard (under a tape);

FIG. 12A is a plan view illustratively showing a peeling nail forming a second modification of a pickup member of the fiberboard splice apparatus according to the embodiment of the invention;

FIG. 12B is a side elevational view illustratively showing the peeling nail forming the second modification of the pickup member of the fiberboard splice apparatus according to the embodiment of the invention;

FIG. 13 is an illustrative view for explaining a single facer and a mill roll stand included in a common corrugate machine;

FIG. 14 is an enlarged view illustratively showing a common fiberboard splice apparatus;

FIG. 15A is an illustrative view for explaining preparation for a fiberboard splice process in the case of employment of a common fiberboard splice apparatus, and shows a state where a new roll fiberboard is carried therein;

FIG. 15B is an illustrative view for explaining the preparation for the fiberboard splice process in the case of employment of the common fiberboard splice apparatus, and shows a state where the new roll fiberboard is lifted;

FIG. 15C is an illustrative view for explaining the preparation for the fiberboard splice process in the case of employment of the common fiberboard splice apparatus, and shows a state where the tip portion of the new roll fiberboard is pulled out; and

FIG. 15D is an illustrative view for explaining the preparation for the fiberboard splice process in the case of employment of the common fiberboard splice apparatus, and shows a state where the new roll fiberboard is led to a fiberboard splice part and a pressure sensitive adhesive double coated tape.

### DESCRIPTION OF THE PREFERRED EMBODIMENTS

Referring to the drawings, a detailed description will be given hereinbelow of a fiberboard splice apparatus, a corrugate machine comprising this fiberboard splice apparatus and a fiberboard splice method according to an embodiment of the present invention.

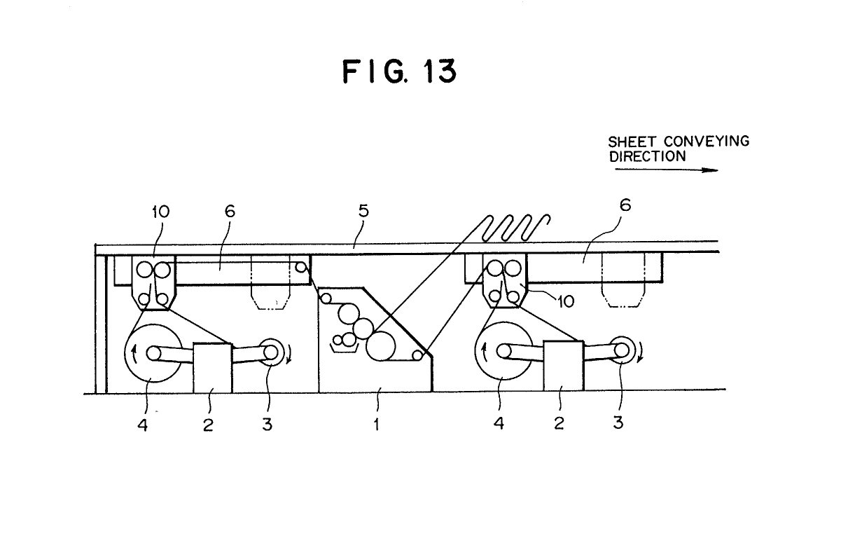

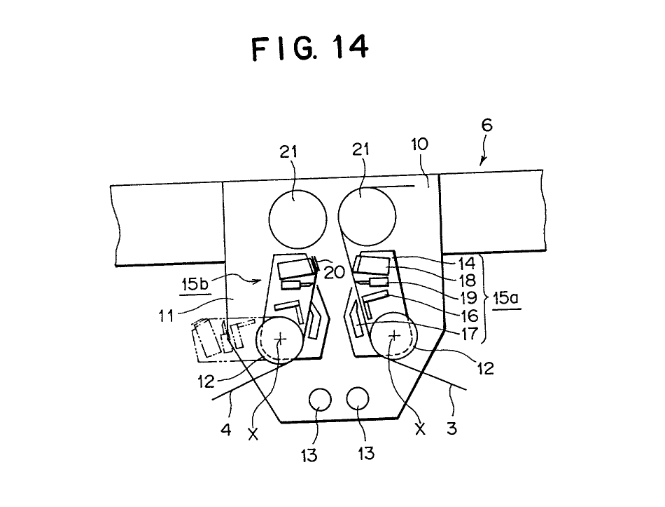

As already described above with reference to FIG. 13, the fiberboard splice apparatus according to this embodiment is installed, for example, before and after a single facer 1 in a corrugate machine, that is, on the upstream and downstream sides in a sheet advancing direction (sheet conveying direction).

A feature of this embodiment is to enable the automization of preparation for a fiberboard splice process to be conducted by this fiberboard splice apparatus.

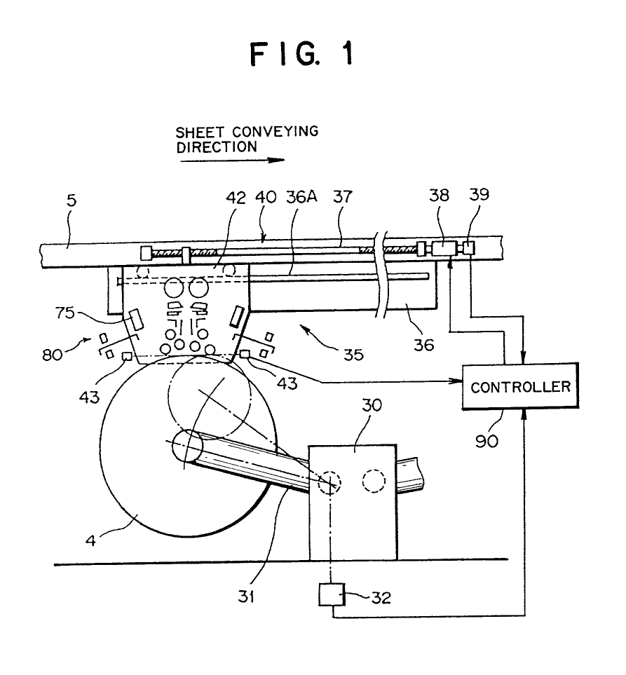

Secondly, this fiberboard splice apparatus will be described hereinbelow with reference to FIGS. 1 to 9.

As FIG. 1 shows, the fiberboard splice apparatus, designated generally at reference numeral 35, is mounted on a bridge 5 extending along a sheet conveying direction above a mill roll stand (which is equally referred to as a roll stand) 30 equipped with an arm 31 for supporting a roll fiberboard 4. The fiberboard splice apparatus 35 comprises a fiberboard splice unit 42 and a fiberboard splice unit moving device 40 comprises a fiberboard splice unit supporter 36 including a screw (threaded) shaft 37, a motor 38 and a rail 36A serving as a guide member for guiding the fiberboard splice unit 42 for moving the fiberboard splice unit 42.

The fiberboard splice unit 42 is supported by the fiberboard splice unit supporter 36 to be movable along the sheet conveying direction (sheet flow direction) in a state guide by the rail 36A.

The screw shaft 37 connected to the motor 38 is fitted in the fiberboard splice unit 42 so that the rotation of the screw shaft 37 by the motor 38 causes parallel movement of the fiberboard splice unit 42 on the rail 36A along the sheet conveying direction. Additionally, the information (for example, the speed of rotation) about the rotation of the motor 38 (that is, the rotation of the screw shaft 37) is read by a rotary encoder 39, which enables precise understanding of the position of the fiberboard splice unit 42.

The motor 38 is made to operate in accordance with a control signal from a controller (control means) 90. The information from the rotary encoder 39 is sent to the controller 90.

Furthermore, on the fiberboard splice unit 42, there is mounted a photoelectric detector (roll fiberboard detection sensor) 43 for sensing an outer-diameter portion of the roll fiberboard (the other roll fiberboard) 4 (in this case, an upper surface portion of the roll fiberboard 4). Thus, it is possible to accurately set the relative position of the roll fiberboard 4 with respect to the fiberboard splice unit 42 on the basis of the detection information from the photoelectric detector 43.

The reason for accurately setting the relative position of the roll fiberboard 4 to the fiberboard splice unit 42 is that the diameter of the new roll fiberboard is not constant. That is, in general, since the corrugate machine is used according to a small order, the fiberboard replacement is done halfway before the roll fiberboard is not completely used up. In this case, the remaining roll fiberboard is kept and again put to use. This means that the remaining roll fiberboard may be used as a new roll fiberboard. For this reason, the diameter of the new roll fiberboard 4 set on the mill roll stand 2 ranges widely from a large diameter in a completely new condition to a small diameter in a little-left condition.

Concretely, as FIG. 1 shows, when the roll fiberboard 4 chucked by the arm 31 of the mill roll stand 2 is lifted and an outer-diameter portion of the roll fiberboard 4 (an upper surface portion of the roll fiberboard 4) is detected by the photoelectric detector 43, the detection information from the photoelectric detector 43 is sent to the controller 90. Additionally, the information from the rotary encoder 32 is also inputted to the controller 90. The controller 90 obtains, on the basis of the information from the rotary encoder 32, an angle of the arm 31 at the time that the outer-diameter portion of the roll fiberboard 4 is detected by the photoelectric detector 43 to calculate a horizontal position of the roll fiberboard 4 and a vertical position thereof (that is, the central position of the roll fiberboard 4) on the basis of the angle information on the arm 31. Still additionally, the controller 90 outputs a control signal to the motor 38, placed in the fiberboard splice unit moving device 40, on the basis of the information (roll fiberboard position information) about the horizontal position and vertical position of the roll fiberboard 4 (namely, the central position of the roll fiberboard 4) and the information (fiberboard splice unit position information) about the position of the fiberboard splice unit 42 from the rotary encoder 39 so that the fiberboard splice unit 42 is accurately aligned with a predetermined position above the roll fiberboard 4 and bearing opposed relation to the roll fiberboard 4. Accordingly, irrespective of the variation of the diameter of the roll fiberboard 4, the fiberboard splice unit 42 can be located at the predetermined position above (almost right above) the roll fiberboard 4.

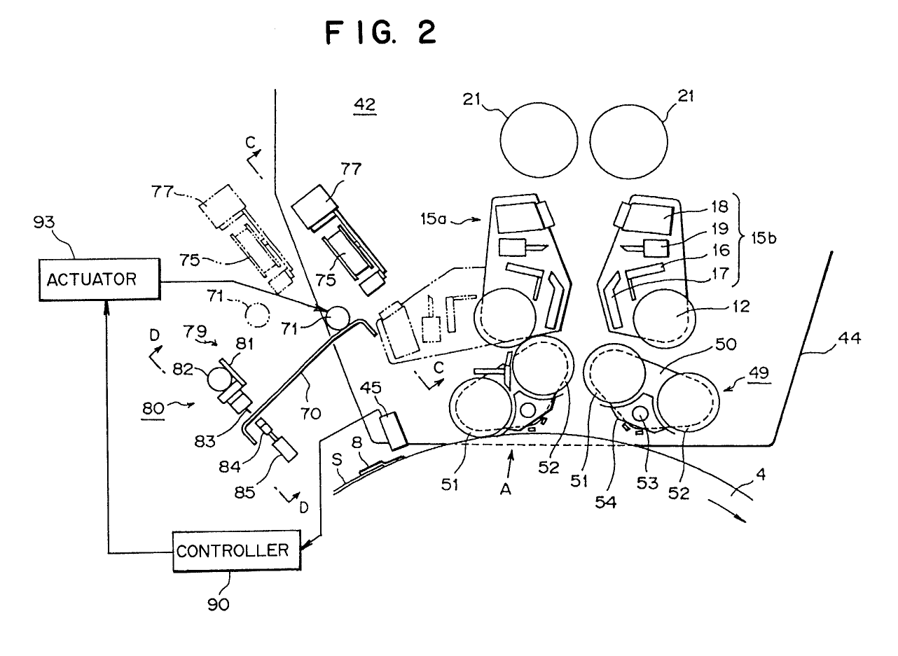

Furthermore, referring to FIG. 2, a description will be given hereinbelow of a concrete construction of the fiberboard splice unit 42.

As FIG. 2 shows, the fiberboard splice unit 42 is made up of a fiberboard splice part 15 including a fixed stop bar 16, a movable stop bar 17, a pressing bar 18, a knife 19 and a guide roll 12, a fiberboard feed device 49 placed under the guide roll 12 of the fiberboard splice part 15, a tape adhering device 75 for adhering a pressure sensitive adhesive double coated tape to an end portion of a new fiberboard fed from the roll fiberboard 4, and a fiberboard end processing device 79 including a table 70, a drive roller 71 and a fiberboard end holding device 80.

The fiberboard splice part 15 is for adhering an end portion of the new fiberboard 4 fed from the roll fiberboard (the other roll fiberboard) 4 to the old fiberboard 3 fed from the roll fiberboard (one roll fiberboard) 3 and presently supplied, and is constructed like that in the above-mentioned related art (see FIG. 13).

The fiberboard feed device 49 is located between the fiberboard splice part 15 and the roll fiberboard 4 for forwarding the new fiberboard 4 to the fiberboard splice part 15.

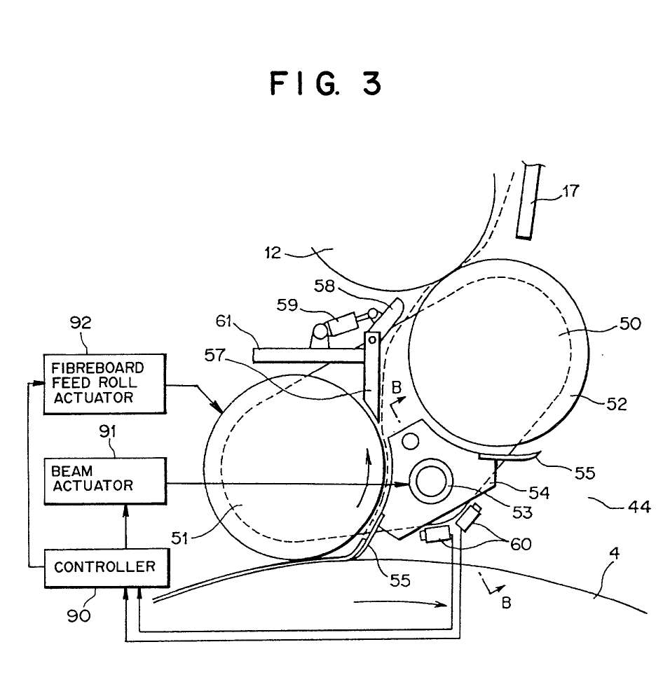

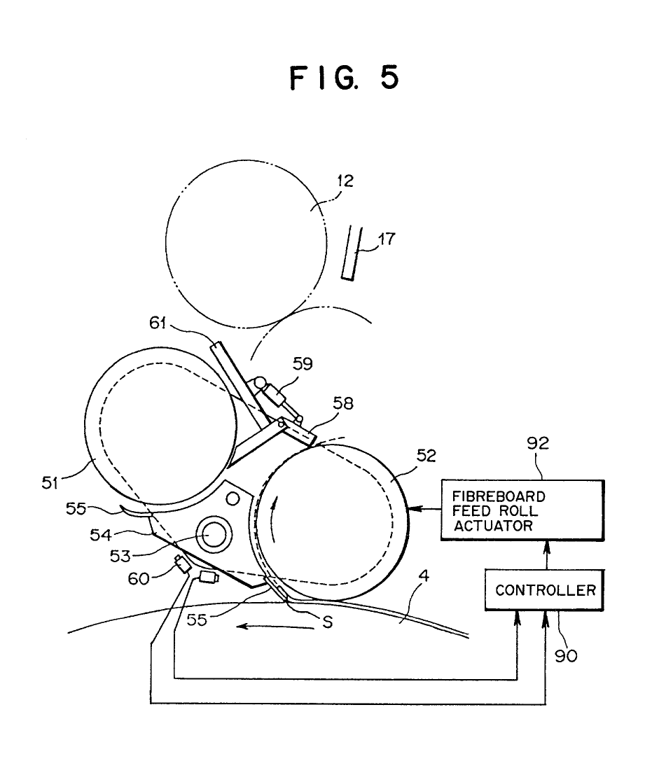

As FIGS. 3 and 5 show, this fiberboard feed device 49 is located along the axial direction of the roll fiberboard 4, and is composed of fiberboard feed rolls 51 and 52 for rotating the roll fiberboard 4 while coming into contact with a surface of the roll fiberboard 4, a plurality of fingers (pickup members) 55 for picking up an end portion of the roll fiberboard 4 while coming into sliding contact with a surface of the roll fiberboard 4, and guide plates 57 and 58 serving as a guide member for guiding the end portion of the roll fiberboard 4, picked up by the fingers 55, to the fiberboard splice part 15.

In this case, not only the guide plates 57 and 58, but also the fiberboard feed rolls 51 and 52 located along a fiberboard feed passage for the new fiberboard fed from the roll fiberboard 4 and a finger fitting plate 54, which will be described later, function as the guide member.

The fiberboard feed rolls 51 and 52 are placed to extend along sheet cross directions (directions perpendicular to the sheet conveying direction), and are for forwarding the unwound roll fiberboard 4 to the fiberboard splice part 15 section. In this construction, a pair of fiberboard feed rolls 51 and 52 are provided, both end portions of each of which are supported by two rocking frames (roll supporting frames) 50 supported on the inner sides of two side frames 44 of the fiberboard splice unit 42 in a rocking-possible condition. A pipe-like beam (bar-like member) 53 is set along the axial directions of the fiberboard feed rolls 51 and 52 to stretch or span between these rocking frames 50 and 50.

The plurality of fingers 55 are attached to a plurality of fitting plates (finger supporting member, pickup member supporting member) 54 fitted over the beam 53. In this construction, a pair of fingers 55 and 55 are supported by each of the plurality of fitting plates 54 to be in opposed relation to a pair of fiberboard feed rolls 51 and 52, respectively.

In addition, with the beam 53 holding the fitting plates 54 supporting the rocking frames 50 and the fingers 55, there is operatively associated a beam actuator (bar-like member actuator) 91 such as a motor. The actuation of the beam actuator 91 causes the beam 53 to be put into rotating motion. Still additionally, the operation of the beam actuator 91 is controlled in accordance with a control signal from the controller 90. In this way, the fiberboard feed device 49 is composed of the fiberboard feed rolls 51, 52, the rocking frames 50, the fitting plates 54 supporting the fingers 55, and the beam 53, and is constructed in the form of a compact unit. This fiberboard feed device 49 is capable of rocking around the axis of the beam 53. Incidentally, in this case, the guide plates 57 and 58 serving as the guide member are also included in this unit.

In this connection, although the beam 53 is automatically driven rotationally in accordance with a control signal from the controller 90 for the rocking motion of the fiberboard feed device 49, it is also appropriate that the rocking motion of the fiberboard feed device is made manually, for example, by manipulating a handle or the like attached to an end portion of the beam 53.

In this case, as FIG. 2 shows, the fiberboard feed device 49 is equipped with a pair of fiberboard feed rolls 50 and 51, which is for coping with a change of the drawing direction of the roll fiberboard 4.

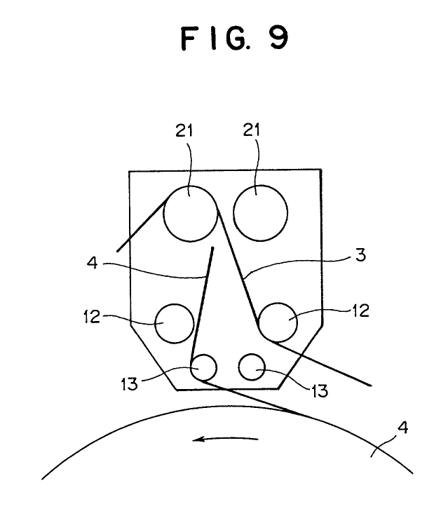

That is, the mill roll stand 2 (the right side in FIG. 13) for supporting the roll fiberboards 3 and 4 constituting a linerboard can deal with not only a case in which the roll fiberboards 3 and 4 are rotated clockwise so that the fiberboards 3 and 4 are drawn out as shown in FIG. 13 (which is referred to as “right-hand supply”) but also a situation in which the roll fiberboard 4 is rotated counterclockwise so that the fiberboard is drawn out as shown in FIG. 9 (which is referred to as “left-hand supply”). FIG. 9 illustrates a traveling path of the fiberboard in the case of the left-hand supply.

This is because a fiberboard has a face and a back and the roll fiberboard is available in a state wound such that its face appears on its outer surface (which is referred to as “face winding”) and in a state wound such that its back appears on its outer surface (which is called “back winding”) and in a case in which the roll fiberboard (supported by the right-hand mill roll stand in FIG. 13) for a linerboard and the roll fiberboard (supported by the left-hand mill roll stand in FIG. 13) for a corrugating medium are adhered to each other to produce a corrugated fiberboard sheet, since the side appearing on the surface preferably forms the fiberboard face, the face-winding roll fiberboard and the back-winding roll fiberboard need to take opposite roll fiberboard drawing directions.

Incidentally, FIG. 13 shows aback-winding condition, while FIG. 9 illustrates a face-winding condition. Additionally, in FIG. 9, reference numeral 13 represents a lower guide roll, with this lower guide roll 13 being to be used in the case of the face-winding (reverse-winding).

In this case, since the roll fiberboard 4 is in the back-winding condition in which the winding is made in a state where the fiberboard back forms its outer surface (see FIG. 13), in the preparation for the fiberboard splice process, as shown in FIG. 3, the beam 53 is rotated so that the surface of the fiberboard feed roll 51 and the tip portion of the finger 55 are brought into contact with the surface of the roll fiberboard 4. At this time, the fiberboard feed roll 52 comes into contact with the surface of the guide roll 12 of the fiberboard splice part 15.

On the other hand, in a case in which the roll fiberboard 4 is in the face-winding condition in which the fiberboard face forms its outer surface, as shown in FIG. 5, the beam 53 is rotated so that the surface of the fiberboard feed roll 52 and the tip portions of the pair of fingers 55 are brought into contact with the surface of the roll fiberboard 4.

In this way, the simple control using the compact fiberboard feed device 49 can handle the roll fiberboard 4 even if the roll fiberboard 4 is in the face-winding condition or in the back-winding condition, which provides a construction suitable for automatic fiberboard feed.

Meanwhile, a fiberboard feed roll actuator 92 such as a motor is operatively associated with these fiberboard feed rolls 51 and 52 so that the fiberboard feed rolls 51 and 52 are driven rotationally by the actuation of the fiberboard feed roll actuator 92. Additionally, the operation of the fiberboard feed roll actuator 92 is controlled in accordance with a control signal from the controller 90.

It is also possible that only one of the fiberboard feed rolls 51 and 52, coming into contact with the roll fiberboard 4 at the fiberboard feed, is put into rotation, or that both are placed into operation. For example, if both are put into operation, through the fiberboard feed roll (the fiberboard feed roll designated at reference numeral 52 in FIG. 3) which does not come into contact with the roll fiberboard 4, it is possible to surely lead the new fiberboard fed from the roll fiberboard 4 to the fiberboard splice part 15.

The tip portion of the roll fiberboard 4 is adhered through a tape 8 to an outer surface of the roll fiberboard 4. Additionally, a color sensor (tape detection sensor) 45 for detecting the color of this unwinding prevention tape (color tape) 8 is placed on the upstream side of the fiberboard feed device 49 (on the upstream side in the rotating direction of the roll fiberboard 4) in a state separated by a predetermined distance from the fiberboard feed device 49. The detection information from this color sensor 45 is sent to the controller 90.

Furthermore, when detecting the presence of the tape 8 on the basis of the detection information from the color sensor 45, the controller 90 places the fiberboard feed roll actuator 92 into operation to implement control so that the rotating speed of the fiberboard feed roll 51 rotating the roll fiberboard 4 while coming into contact with the surface of the roll fiberboard 4 becomes lower than a predetermined rotating speed forming a reference value. Thus, the finger 55 can securely pick up an end portion of the new fiberboard 4. This provides a construction suitable for the automization of the fiberboard splice apparatus.

In this case, it is preferable that the tape 8 (if a plurality of tapes are adhered thereto, at least one of them) is a color tape which is easily detectable by the color sensor 45. Additionally, preferably, the adhering position of the tape 8 is determined, for example, to be separated by a substantially constant distance from the central portion of the roll fiberboard 4 in the cross direction. Still additionally, it is also appropriate that the adhering position of the tape 8 is not determined but the color sensor 45 is designed to be movable in the cross directions of the roll fiberboard 4 to detect the presence or absence of the tape 8. Still additionally, in this case, although the color sensor 45 is used for detecting the presence or absence of the tape 8, the present invention is not limited to this, but it is also acceptable to employ a different tape detection sensor whereby the presence of the tape 8 is detectable.

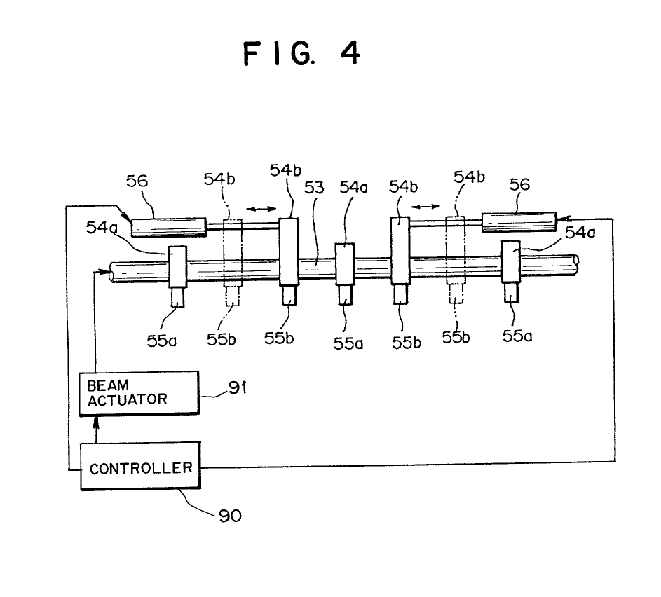

As FIG. 4 shows, as the plurality of fingers 55, there are fixed fingers 55a attached to fitting plates 54a fixed to the beam 53 and movable fingers 55b attached to fitting plates 54b fitted over the beam 53 to be movable in the axial directions of the beam 53.

In addition, a fitting plate actuator (finger actuator, pickup member actuator) 56 is operatively associated with each of the fitting plates 54b to which the movable fingers 55b are attached, so that the fitting plates 54b can reciprocate in the axial directions of the beam 53 as indicated by arrows in FIG. 4. When the movable fingers 55b are shifted along the axial directions of the beam 53, since the beam 53 is located in parallel with the roll fiberboard 4 wound in the form of a roll, the movable fingers 55b are shifted in the axial directions along the surface of the roll fiberboard 4. Accordingly, the tip portions of the fingers 55 enter under the end portion S of the fiberboard lying between a plurality of tapes 8 adhered to the fiberboard end portion S, and in this state, when the fingers 55 are shifted in the axial directions of the beam 53 (namely, in the sheet cross directions) by means of the finger actuators 56, the tapes 8 are cut by the sharp-edged side surfaces of the fingers 55.

In this connection, in the fiberboard feed device 49, in the vicinity of the fingers 55, a sensor (fiberboard detection sensor) such as a reflection type photoelectric detector 60 is provided to detect the tip portion of the new fiberboard 4 picked up by the fingers 55, with the detection information from this sensor 60 being forwarded to the controller 90 (not shown). Additionally, when the sensor 60 has sensed the tip portion of the roll fiberboard 4, the controller 90 outputs a signal to the fiberboard feed roll actuator 92 for stopping the rotation of the fiberboard feed roll 51 (or the fiberboard feed roll 52), and further issues a signal to the finger actuator 56. Thus, the fingers 55 shift in the axial direction of the roll fiberboard 4 for cutting the tapes 8. The employment of this construction contributes greatly to the automization of the fiberboard splice apparatus.

In FIG. 4, the states of the movements of the movable fingers 55b and the fitting plates 54b are indicated by two-dot chain lines. Additionally, in this case, although the fixed fingers 55a and the movable fingers 55b are disposed alternately, the present invention is not limited to this, but there is a need to set the adhering positions of the tapes 8 within at least the movable range of the movable fingers 55b.

Furthermore, as FIG. 3 shows, the fitting plates 54 are supported by the beam 53 located in a space defined between the fiberboard feed rolls 50 and 51, and the surfaces thereof facing the fiberboard feed rolls 50 and 51 have a circular-arc configuration, with the fingers 55 being attached to end portions of the circular-arc surfaces thereof. Accordingly, the roll fiberboard 4 led through the fingers 55 is guided through a constant-width fiberboard feed passage defined between the surface of each of the fiberboard feed rolls 50 and 51 and the circular-arc surface of each of the fitting plates 54.

The guide plates 57 and 58 serving as a guide member are placed in a space defined between the pair of fiberboard feed rolls 50 and 51.

As FIG. 3 shows, the guide plate 57 extends along the sheet cross direction, and one end portion thereof is located in a state fixed to a supporting member 61 to be in opposed relation to the surface of the one fiberboard feed roll 51. Accordingly, this guide plate 57 is equally called “fixed guide plate”. This guide plate 57 is located in a space defined between the fiberboard feed rolls 50 and 51, and one end portion thereof is placed in a state adjacent to the fitting plate 54 to face an end portion of the fitting plate 54 (end portion on the opposite side to the location of the fingers 55), thereby certainly guiding the roll fiberboard 4, coming along a side surface of the fitting plate 54, to the fiberboard splice part 15 side.

In addition, as FIG. 3 shows, one end portion of the guide plate 58 is attached to the other end portion of the fixed guide plate 57 in a freely rocking condition.

This means that the guide plate 58 is constructed as a movable guide member touchable/separable on/from the surface of the fiberboard feed roll 52. Concretely, to the guide plate 58, there is fitted a guide plate actuator 59 such as an air cylinder, which provides a rocking motion of the guide plate 58 so that the other end portion of the guide plate 58 is brought into contact with and separated from the surface of the other fiberboard feed roll 50 to lead the roll fiberboard 4 to between the guide plate 58 and the fiberboard feed roll 50, thereby achieving the certain guiding of the roll fiberboard 4 to the fiberboard splice part 15 side. For this reason, this guide plate 58 is equally called “rocking guide plate”. Incidentally, the guide plate actuator 59 is mounted on the supporting member 61.

In this embodiment, as mentioned above, since the roll fiberboard 4 is in the back-winding condition in which the fiberboard back forms its outer surface (see FIG. 13), in the preparation for the fiberboard splice, the beam 53 is put into rotation so that the surface of the fiberboard feed roll 51 and the tip portions of the fingers 55 come into contact with the surface of the roll fiberboard 4 as shown in FIG. 3. At this time, the fiberboard feed roll 52 comes into contact with the surface of the guide roll 12 of the fiberboard splice part 15.

In this case, when the beam 53 is put into rotation to set the fiberboard feed device 49 at a position (first position) where the fiberboard feed roll 51 and the fingers 55 are touchable on the roll fiberboard 4, as shown in FIG. 3, the guide plate (movable guide member) 58 comes to a position separated from the surface of the fiberboard feed roll 52 to establish a fiberboard feed passage (path indicated by a broken line in FIG. 3) extending from a portion between the fingers 55 and the fiberboard feed roll 51 to the fiberboard splice part 15 along the guide plate 58 so that the new fiberboard 4 is guided through the fiberboard feed passage.

On the other hand, in a case in which the roll fiberboard 4 has the face-winding form in which the fiberboard face forms its outer surface, as shown in FIG. 5, the beam 53 is placed into rotation so that the surface of the fiberboard feed roll 52 and the tip portions of the pair of fingers 55 are brought into contact with the surface of the roll fiberboard 4.

In this case, when the beam 53 is placed into rotation to set the fiberboard feed device 49 at a position (second position) where the fiberboard feed roll 52 and the fingers 55 are touchable on the roll fiberboard 4, as shown in FIG. 5, the guide plate 58 is shifted in a direction of approaching the surface of the fiberboard feed roll 52 and hold an end portion of the new fiberboard 4 led through a space between the fingers 55 and the fiberboard feed roll 52. In this state, the beam 53 is rotated to move the fiberboard feed device 49 to the first position so that the new fiberboard 4 is guided through the fiberboard feed passage. Thus, even if the roll fiberboard 4 is in the reverse-winding condition, it is possible to surely lead the new fiberboard 4 to the fiberboard splice part 15.

The tape adhering device 75 is positioned to face the pressing bar 18 of the fiberboard splice part 15 in a state where the fiberboard splice part 15 is pushed down for the preparation for the fiberboard splice process as indicated by a two-dot chain line in FIG. 2. This tape adhering device 75 can accept a well-known construction, for example, the construction disclosed in Japanese Patent Laid-Open No. (SHO) 61-111264. That is, the tape adhering device 75 is designed to automatically cut an end portion of the roll fiberboard 4 concurrently with adhering a pressure sensitive adhesive double coated tape 20. For this function, a fiberboard cutting knife 76 is provided additionally. This can achieve the automization of the fiberboard splice apparatus. Incidentally, in the preparatory stage for the fiberboard splice process, the tape adhering device 75 is retreated to a position indicated by a two-dot chain line in FIG. 2 to prevent the fiberboard splice part 15 from constituting an obstacle.

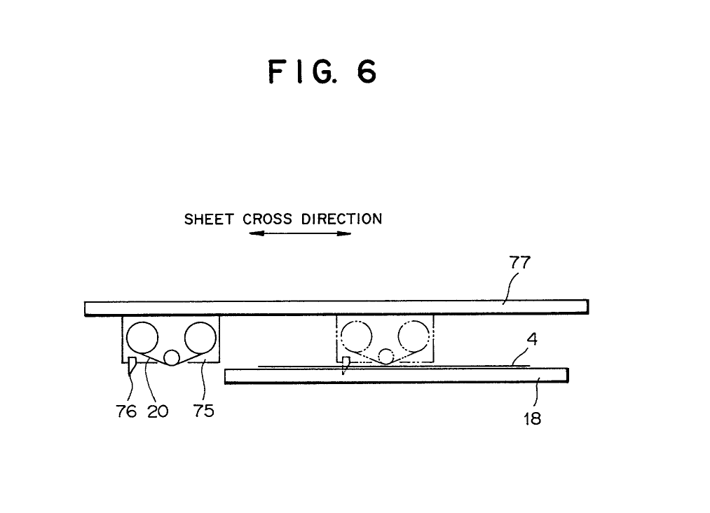

As FIG. 6 shows, this tape adhering device 75 is designed to adhere the pressure sensitive adhesive double coated tape 20 to the cut end portion of the new fiberboard 4 while traveling on a rail 77 extending along the sheet cross direction (machine cross direction).

In addition, the tape adhering device 75 is equipped with a knife 76 to cut the roll fiberboard 4 along the sheet cross direction concurrently with adhering the pressure sensitive adhesive double coated tape 20.

The fiberboard end processing device 79 is, as shown in FIG. 2, made up of a table 70 for supporting and guiding the new fiberboard 4 to be led through the fiberboard splice part 15 to the fiberboard end holding device (fiberboard holding device) 80, the drive roller 71 disposed to be touchable and separable on and from the table 70, and the fiberboard end holding device 80 disposed in a state where the table 70 is interposed, and is for cutting and removing a predetermined length (for example, one turn of the roll) of the tip portion of the new fiberboard 4. This can automate the fiberboard splice apparatus. Incidentally, the drive roller 71 is driven rotationally by a drive roller actuator 93 such as a motor in accordance with a control signal from the controller 90.

Of these parts, in the preparatory stage for the fiberboard splice process, the table 70 is placed to protrude from the interior of the fiberboard splice unit 42 to the exterior thereof so that it is linked with a surface position (pressing surface position) of the pressing bar 18 of the fiberboard splice part 15 pushed down as indicated by the two-dot chain line in FIG. 2.

The drive roller 71 is for leading the roll fiberboard 4, guided through the fiberboard splice part 15, to the fiberboard end holding device 80. This drive roller 71 is made to be touchable and separable on and from a surface of the table 70, and is retreated to a position indicated by a two-dot chain line in FIG. 2 in connection with the tape adhering device 75 in the preparatory stage for the fiberboard splice process to prevent the fiberboard splice part 15 from constituting an obstacle in the preparatory stage.

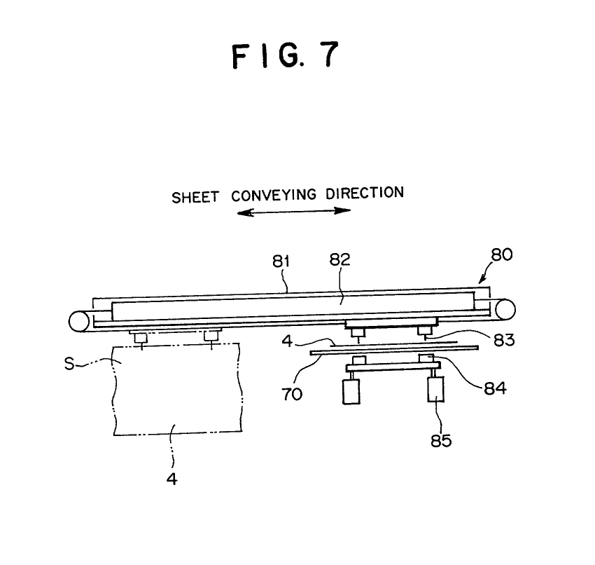

As FIG. 7 shows, the fiberboard end holding device 80 is composed of a needle supporter (locking member supporting member) 83 having a plurality of needles (locking members) 83a each having a hooking section at its tip portion, and a bearing plate 84 placed on the opposite side to the needles 83a in a state the table 70 is interposed therebetween.

The needle supporter 83 is driven by a cable cylinder (locking member supporter reciprocating device) 82 to be capable of reciprocating on a rail (guide member) 81 extending in the sheet cross directions (machine cross directions). Therefore, the fiberboard cut off on the table 70 can be shift sideways in a state hooked by the tip portions of the plurality of needles 83a.

The bearing plate 84 is driven by an air cylinder (bearing plate actuator) 85 to be movable toward the needles 83a. On the movement of the bearing plate 84 in this way, the tip portions of the needles 83a stick in the tip portion of the roll fiberboard 4.

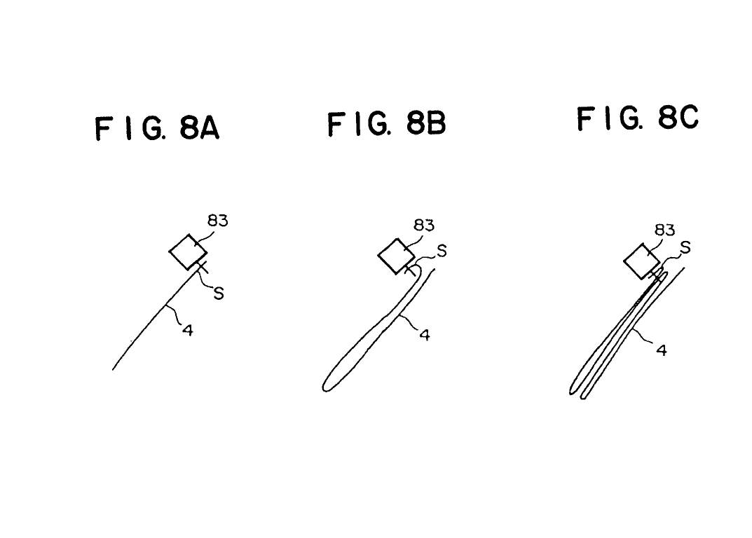

Referring to FIGS. 8A to 8C, a description will be given hereinbelow of various methods of cutting the end portion of the roll fiberboard 4 to carry away some length to the outside of the machine.

First, in a case in which the length of the fiberboard to be removed is relatively short, as shown in FIG. 8A, the drive roller 71 feeds the roll fiberboard 4 by a length to be cut and removed with respect to the position of the pressing bar 18 (tape adhering position). Following this, the bearing plate 84 is moved in a direction of approaching the needle 83a so that the needle 83a sticks in the roll fiberboard 4, and is then returned to the original position. In this state, a pressure sensitive adhesive double coated tape 20 is adhered to a position separated by a predetermined distance (corresponding to the length to be removed) from the tip of the roll fiberboard 4 and, at the same time, the roll fiberboard 4 is cut there. Thereafter, as shown in FIG. 7, the fiberboard end holding device 80 is shifted sideways in the state where the fiberboard end S is hooked by the needle 83a, and the fiberboard end S is carried away to the exterior of the machine for the disposal. In this case, since the needle 83a has a hook portion, the fiberboard end S cut off from the roll fiberboard 4 does not come out of the needle 83a.

Furthermore, in a case in which the length to be removed is somewhat long, as shown in FIG. 8B, the tip portion of the roll fiberboard 4 is first held in a state where the needle 83a sticks thereinto. Subsequently, the roll fiberboard 4 is fed by the drive roller 71 to form the end portion of the roll fiberboard 4 into a loop configuration as shown in FIG. 8B. Following this, when this loop portion reaches a predetermined length, the drive roller 71 is stopped to cease the feeding of the roll fiberboard 4. Additionally, the needle 83a is driven to again stick into the roll fiberboard 4. In this state, the roll fiberboard 4 is cut while the pressure sensitive adhesive double coated tape 20 is adhered to a surface of the roll fiberboard 4 over the pressing bar 18 by means of the tape adhering device 75. Then, as shown in FIG. 7, in the state where the fiberboard end S is hooked by the needle 83a, the fiberboard end holding device 80 is moved sideways to carry the cut-off fiberboard end S to the exterior of the machine for disposing of it.

Still furthermore, in a case in which the length to be removed is relatively long, as shown in FIG. 8C, the fiberboard of the relatively long length is cut and removed after the repetition of the sticking operation by the needle 83a and the roll fiberboard 4 feeding operation by the drive roller 71, and in this case, the fiberboard of the length to be removed is folded into an appropriate easy-to-handle length. Thereafter, similarly, the roll fiberboard 4 is cut while the pressure sensitive adhesive double coated tape 20 is adhered to a surface of the roll fiberboard 4 over the pressing bar 18 by means of the tape adhering device 75. Additionally, as shown in FIG. 7, the fiberboard end holding device 80 is moved sideways in a state where the fiberboard end S is hooked by the needle 83a so that the fiberboard end S cut off is conveyed to the exterior of the machine for the disposal.

Since the fiberboard splice apparatus and the corrugate machine including this apparatus are constructed as described above, the fiberboard splice method for use in this apparatus is as follows.

(1) Preparatory Process for Fiberboard Splice Process from Chucking of New Roll Fiberboard 4 to Positioning of Fiberboard Splice Unit 42

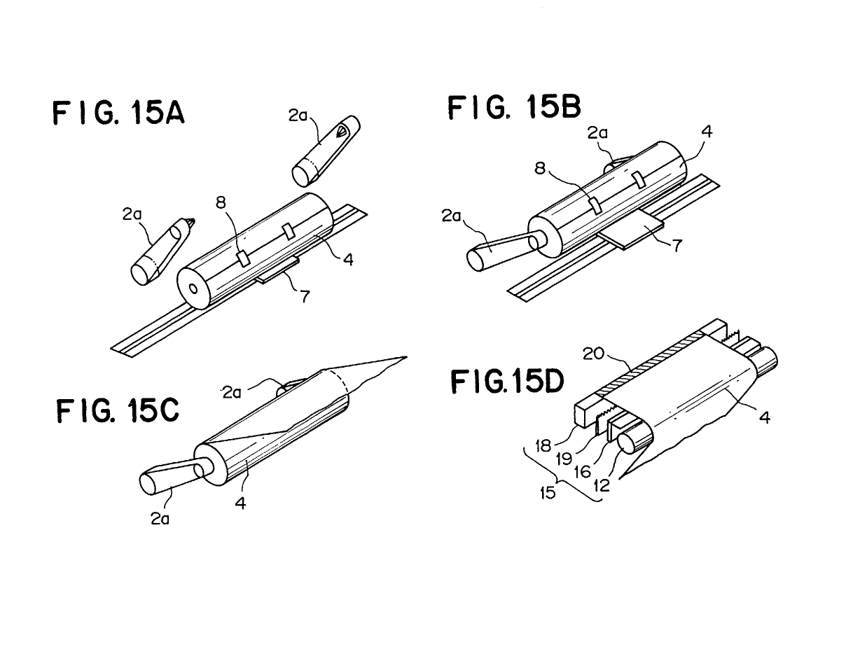

First, as in the case of the conventional art, the new roll fiberboard 4 is conveyed through the fiberboard supply carriage 7 to the central section of the mill roll stand 30 (see FIG. 15A).

Subsequently, the new roll fiberboard 4 is chucked by the arm 31 of the mill roll stands 2 (see FIG. 15B), and as shown in FIG. 1, is lifted until an outer-diameter portion of the roll fiberboard 4 (an upper surface portion of the roll fiberboard 4) is detected by the photoelectric detector 43.

In this case, the angle of the arm 31 is obtained on the basis of the information from the rotary encoder 32 so that the horizontal position and vertical position of the roll fiberboard 4 (namely, the central position of the roll fiberboard 4) are calculated as a function of the obtained angle of the arm 31, thereby implementing control to precisely align the fiberboard splice unit 42 with a predetermined position above the roll fiberboard 4 at all times on the basis of this data and the data (information) on the position of the fiberboard splice unit 42 from the rotary encoder 39. Accordingly, even if the diameter of the roll fiberboard 4 varies, it is possible to bring the fiberboard splice unit 42 to the predetermined position above (almost just above) the roll fiberboard 4 at all times.

In addition, since the position of the roll fiberboard 4 in its height direction is also calculable, it is also possible to calculate the radius of the roll fiberboard 4 on the basis of the relationship with the fitting position (height) of the photoelectric detector 43, with this value being used in a different process.

(2) Process for Detecting Fiberboard End Position and Cutting Unwinding Prevention Tape

First, the upper surface of the roll fiberboard 4 is detected by the photoelectric detector 43 for positioning the fiberboard splice unit 42 as mentioned above, and the fiberboard feed roll 51 is pressed against the surface of the roll fiberboard 4 as shown in FIG. 3. In this state, the fiberboard feed roll 51 is rotated, and when the color of the unwinding prevention tape 8 attached to the fiberboard end S of the roll fiberboard 4 is detected by the color sensor 45, the rotating speed of the fiberboard feed roll 51 is controlled to a low value.

Secondly, behind the fiberboard feed roll 51, the fingers 55 wait for the arrival of the fiberboard end S which coming into contact with the surface of the roll fiberboard 4. When the fiberboard end S advances, the tip portions of the fingers 55 get under the fiberboard end S to pickup the fiberboard end S. Thereafter, when the sensor 60 has detected the fiberboard end S picked up by the fingers 55, the rotation of the fiberboard feed roll 51 is stopped.

Furthermore, in a state where the tip portions of the fingers 55 have got under the fiberboard end S between a plurality of tapes 8 attached to the fiberboard end S, the fingers 55 are shifted in the axial direction (sheet cross direction) of the beam 53 by the finger actuator 56 so that the sharp side surfaces of the fingers 55 cut the tapes 8.

Incidentally, although FIG. 3 shows a state in which the fiberboard feed roll 51 is pressed against the surface of the roll fiberboard 4, the roll fiberboard 4 winding direction determines which of the fiberboard feed rolls 51 and 52 is pressed against the surface of the roll fiberboard 4.

A description will be given hereinbelow of processing in a case of left-hand winding. FIG. 5 shows a state in which the fiberboard feed roll 52 is pressed against the surface of the roll fiberboard 4.

In the left-hand winding case, as shown in FIG. 5, in a state where the fiberboard feed roll 52 is pressed against the roll fiberboard 4, the roll fiberboard 4 being the fiberboard wound into a roll configuration is rotated in a direction opposite to that in the right-hand winding. The processing up to the cutting of the tapes 8 is the same as that in the right-hand winding case.

In this case, after the tape cutting, the fiberboard end S of the roll fiberboard 4 is forwarded as indicated by a broken line in FIG. 5, and when further forwarded, since a large gap exists between the guide roll 12 and the fiberboard feed roll 52, the guiding of the tip portion (fiberboard end S) of the roll fiberboard 4 becomes unstable. For this reason, when the roll fiberboard 4 is forwarded a predetermined length, the guide plate 58 is driven to rock for fixing the fiberboard end S in a state interposed between the guide plate 58 and the fiberboard feed roll 52, and in this state, the fiberboard feed device 49 is driven to rock for bringing the fiberboard end S to a position corresponding to that in the case of the right-hand winding. Thereafter, the fiberboard feed roll 52 is put into rotation for drawing out the roll fiberboard 4. In this way, the fiberboard tip portion is fed to the fiberboard splice part 15 side.

(3) Process of Handling Fiberboard End

When the cutting of the tape 8 has been conducted as mentioned above, the fiberboard feed roll 51 again rotates the roll fiberboard 4, wound into a rolled configuration, for feeding the fiberboard. In FIG. 3, the state of this fiberboard feed is indicated by a broken line. In this case, the fiberboard splice part 15 is in the state pushed down to the preparatory position (the state indicated by a two-dot chain line in FIG. 2), and the fiberboard end S is forwarded toward the table 70 while being guided by the guide plates 57, 58 and the stop bars 16, 17.

Furthermore, in a state where the fiberboard end S is held by the fiberboard end holding device 80, the pressure sensitive adhesive double coated tape 20 is adhered thereto by the tape adhering device 75, and the fiberboard end S is cut off at the same time. Following this, the fiberboard splice part 15 is returned to the fiberboard preparatory position (the position indicated by the solid line in FIG. 2). In this case, although the fiberboard somewhat gets loose due to the sheet path relationship, this is absorbable in a manner that the roll fiberboard 4 is rotated in the reverse direction. Now, the preparatory work for the fiberboard splice process reaches completion.

Accordingly, with the fiberboard splice apparatus, the corrugate machine including this apparatus and the fiberboard splice method according to the present invention, since each of the components of the fiberboard splice apparatus is made to be suitable for automation, it is possible to fully automate, particularly, the preparatory work for the fiberboard splice process, which can shorten the time needed for the preparation therefor to enhance the machine availability factor.

In the above-described embodiment, although the present invention has been applied to the fiberboard splice apparatus (that is, for corrugating medium or for linearboard) located on the upstream and downstream sides of a single facer in a corrugate machine, the invention is not limited to this. For example, it is also appropriate that the invention is applied to a fiberboard splice apparatus to be placed in connection with a double facer in a corrugate machine. In this case, among the double facers, there are various types for manufacturing various double faced corrugated fiberboard sheets such as single wall corrugated fiberboard sheet, double wall corrugated fiberboard sheet and triple wall corrugated fiberboard sheet, and the present invention is also applicable to these double facers.

In addition, in the above-described embodiment, although the present invention has been applied to the fiberboard splice apparatus placed in a corrugate machine, the invention is not limited to this, but is also applicable widely to, in a system for continuously supplying a fiberboard from a roll fiberboard, a fiberboard splice apparatus for connecting a new fiberboard to an old fiberboard in an overlapped condition during supply, for example, when a roll fiberboard being supplied has used up or when it is replaced with a different kind of roll fiberboard. Still additionally, the construction of the fiberboard splice part 15 is not limited to that in the above-described embodiment.

Moreover, in the above-described embodiment, although the fiberboard feed device 49 is composed of a pair of fiberboard feed rolls 51, 52, a pair of sensors 60, a pair of fingers 55 and other pairs of components to set up an axial symmetry with respect to a line extending in the beam 53 for coping with both the right-hand winding roll fiberboard and left-hand winding roll fiberboard, if the fiberboard feed device 49 is required to handle only one of the face-winding roll fiberboard and the reverse-winding roll fiberboard, it can be made up of only the components therefor.

Particularly, in the case of the splice of the roll fiberboard fed as a linerboard, it is preferable to construct the fiberboard feed device 49 as with the above-described embodiment so as to cope with both the face-winding and reverse-winding. On the other hand, in the case of the splice of the roll fiberboard fed as a corrugating medium, regardless of whether in the face-winding or in the reverse-winding, the fiberboard feed roll, the sensor, finger and others may be one in number.

Still moreover, the fiberboard splice section to be provided in the fiberboard splice unit 42 according to the above-described embodiment is not limited to the above-mentioned construction, but any construction is also acceptable as long as an end portion of one roll fiberboard is adhered to the other roll fiberboard for the fiberboard splice. For example, it is also acceptable that a gluing device is provided to apply a glue or paste on an end portion of a new fiberboard or to adhere a pressure sensitive adhesive double coated tape thereto.

Furthermore, in the above-described embodiment, although the fiberboard end processing device is used, there is no need to use this device, for example, in a case in which it is unnecessary to cut off a fiberboard end of the roll fiberboard or in a case of processing that portion after the formation of a corrugated fiberboard sheet.

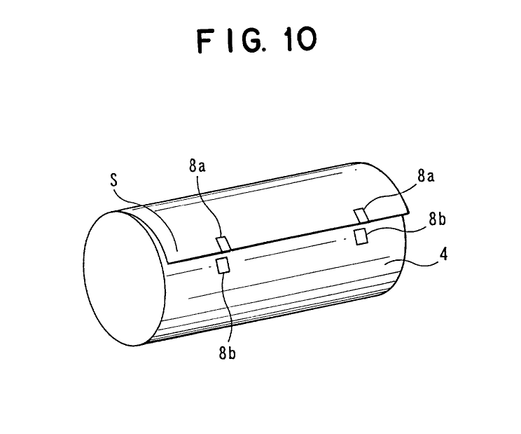

Still furthermore, in the above-described embodiment, as a manner to deal with the tapes 8 which fix the tip portion (fiberboard end S) of the roll fiberboard 4, the tapes 8 are picked up and cut by the fingers, and in this tape removing manner, as shown in FIG. 10, one portion 8a of each of the tapes 8 cut off remains on the tip portion of the roll fiberboard 4 while the other portion 8b remains on an outer-circumferential surface of the roll fiberboard 4 separated by approximately one turn from the tip portion thereof.

In general, since the rear surface side (the surface opposite to the adhesive surface) the tape 8 is made of a smooth material free from the attachment of a glue, if, in manufacturing a corrugated fiberboard sheet, the roll fiberboard 4 is spliced to another roll fiberboard in a state where the tapes 8 (8a, 8b) remain on the surface thereof, a glue does not stick onto the rear surface side of the tapes 8, so an adhesion trouble can occur. For this reason, a portion of the uppermost layer of the roll fiberboard 4, corresponding to one turn (the length corresponding to one turn of the roll fiberboard 4 from its tip portion) is cut off and removed in the usual way. However, since this leads to a loss of material, preferably, the tapes 8 are peeled, without being cut, so that the tape portions 8b do not remain on the surface of the roll fiberboard 4.

Thus, it is considered that the tapes 8 are peeled as stated in the following (1) and (2).

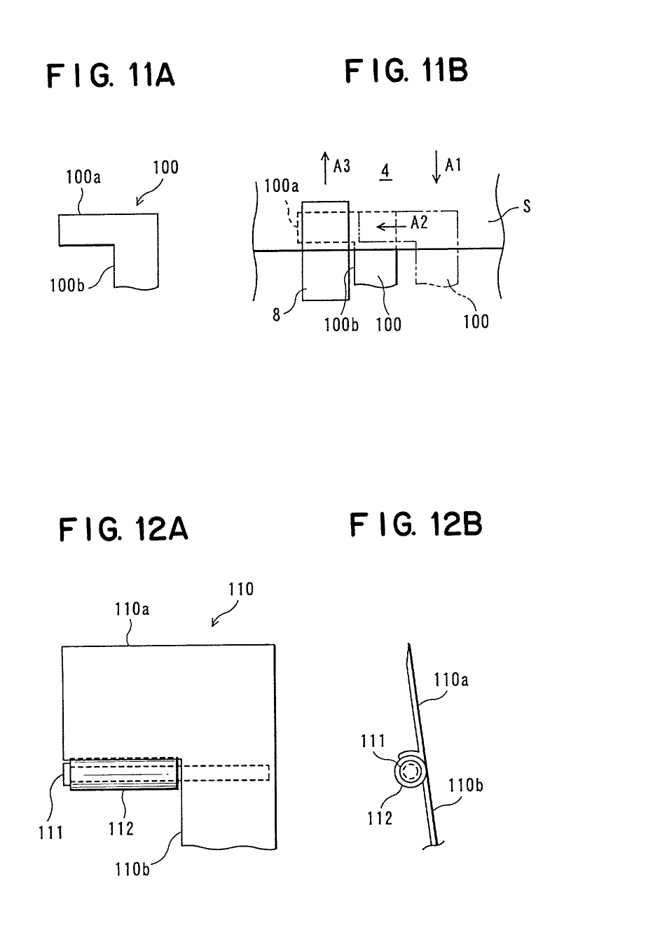

(1) For example, as FIGS. 11A and 11B show, in place of the movable finger 55b in the above-described embodiment, a peeling nail (pickup member) 100 having a hook (key) portion 100a is placed at a tip side portion touchable on an outer circumferential surface of the roll fiberboard 4 to pick up the tip portion (fiberboard end S) of the roll fiberboard 4 for peeling the tape 8. the other construction and fiberboard splice method are similar to those in the above-described embodiment.

The length of the hook portion 100a can be set to be approximately equal to the width of the tape 8 to be used for fixing the end portion of the roll fiberboard 4, as shown in FIG. 11B.

Furthermore, when the tapes 8 are peeled by using the peeling nail 100, the roll fiberboard 4 is first rotated in a direction indicated by an arrow A1 in FIG. 11B (in the rotating direction taken in feeding the roll fiberboard 4), and the tip side hook portion 100a of the peeling nail 100 is put under the fiberboard end S between the plurality of tapes 8 attached to the fiberboard end S as indicated by a two-dot chain line.

Secondly, in this state, the peeling nail 100 is shifted (see an arrow A2) in an axial direction of the beam 53 (that is, in the sheet cross direction) by means of a peeling nail actuator (in the above-described embodiment, called the finger actuator; pickup member actuator) 56 so that the hook portion 100a of the peeling nail 100 is positioned under the tapes 8 fixing the tip portion (fiberboard end S) of the roll fiberboard 4 as shown in FIG. 11B.

Furthermore, in this state, the roll fiberboard 4 is rotated in the direction indicated by an arrow A3 in FIG. 11B (in the direction opposite to the rotating direction taken in feeding the roll fiberboard 4), so that the hook portion 100a peel the tapes 8 off the surface of the roll fiberboard 4.

Accordingly, the fiberboard splice apparatus is made up of the fiberboard detection sensor 60 for detecting the roll fiberboard 4 picked up by the peeling nail 100, the peeling nail actuator 56 for moving the peeling nail 100 in the axial direction of the roll fiberboard 4, the fiberboard feed roll actuator 92 for rotating the fiberboard feed roll 51 (52), and the controller (control means) 90 for outputting control signals to operate the peeling nail actuator 56 and the fiberboard feed roll actuator 92.

In addition, the controller (control means) 90 outputs a signal to the fiberboard feed roll actuator 92 for stopping the rotation of the fiberboard feed roll 51 (52) when the fiberboard detection sensor 60 has detected the roll fiberboard 4, and further outputs a signal to the peeling nail actuator 56 for shifting the peeling nail 100 toward under the tape 8, and even outputs a signal to the fiberboard feed actuator 92 for rotating the fiberboard feed roll 51 (52) in the reverse direction in the state where the peeling nail 100 lies under the tape 8, thereby peeling the tape 8.

Therefore, the tape 8 is peeled by the peeling nail 100 without being cut; in consequence, the tape 8 remains at the tip portion (fiberboard end S) of the roll fiberboard 4 while the tape 8 (8b) is not left on the surface of the roll fiberboard 4.

Accordingly, unlike the above-described embodiment, there is no need to cut off the roll fiberboard (new fiberboard) 4, for example, by a length corresponding to one turn thereof from the tip portion, but it becomes possible to cut off the roll fiberboard 4 by a predetermined length (corresponding to the length of the tape 8 adhered to the tip portion of the roll fiberboard 4) from the tip portion thereof, which reduce the loss of material.

Incidentally, it is also appropriate that the peeling nail 100 is constructed such that the edge portion 100b constituting the side surface thereof (the side surface on the side to which the hook portion 100a extends) is formed into a sharp knife edge. Thus, the peeling nail 100 can also be used to cut the tape 8 like the case of the finger 55 in the above-described embodiment. This provides a choice between the cutting of the tape 8 and the peeling thereof based on the conditions such as the type of fiberboard.

In addition, the finger supporting member in the above-described embodiment corresponds to the peeling nail supporting member (pickup member supporting member), while the finger actuator corresponds to the peeling nail actuator (pickup member actuator).

(2) Furthermore, there is provided another peeling nail (pickup member) 110 having, for example, a construction shown in FIGS. 12A and 12B. This peeling nail 110 is basically constructed in the same manner as that of the peeling nail 110 described in the above-mentioned (1), except that a roller 112 is rotatably attached to one end portion side (the side opposite to the tip portion side of the hook portion 110a) of the hook portion 110a. The other structure and fiberboard splice method are the same as those in the above-described (1) or embodiment.

That is, for picking up the tip portion (fiberboard end S) of the roll fiberboard 4 to peel the tape 8, the peeling nail 110 has a hook portion 110a at its tip side portion touchable on the outer circumferential surface of the roll fiberboard 4, and the roller 112 is rotatably attached through a pin 111 to the peeling nail 110 in a state adjoining one end side of the hook portion 110a (the side opposite to the tip portion side of the hook portion 110a). The roller 112 is made to be brought into contact with the outer circumferential surface of the roll fiberboard 4 so that it rotates with the rotation of the roll fiberboard 4.

This is because, in the peeling nail 100 mentioned above in (1), the adhesion surface of the tape 8 peeled comes into contact with the upper surface of the hook portion 100a to easily cause the tape 8 to stick to the hook portion 110a of the peeling nail 100 so that the tip portion (fiberboard end S) of the roll fiberboard 4 is pulled by the tape 8 attached to the hook portion 100a to cause the roll fiberboard 4 to tear or to cause the tape 8 to be peeled off the tip portion (fiberboard end S) of the roll fiberboard 4 to stick to the hook portion 100b of the peeling nail 100.

In this case, since the roller 112 is set in a rotatable condition, even if the tape 8 tends to stick to the peeling nail 110 (has a tendency to adhesion), the rotation of the roller 112 eliminates the sticking of the tape 8 to the hook portion 110a of the peeling nail 110, and prevents the tip portion (fiberboard end S) of the roll fiberboard 4 from being pulled by the tape 8 attached to the hook portion 110a to tear the roll fiberboard 4 or prevents the tape 8 from being peeled off the tip portion (fiberboard S) of the roll fiberboard 4 to stick to the hook portion 110b of the peeling nail 110.

Incidentally, it is also appropriate that, as with the case (1) mentioned above, the peeling nail 110 is such that the edge portion 110b constituting the side surface thereof (the side surface on the side to which the hook portion 110a extends) is formed into a sharp knife edge. Thus, the peeling nail 110 can also be used to cut the tape 8 like the case of the finger 55 in the above-described embodiment. This offers a choice between the cutting of the tape 8 and the peeling thereof according to the conditions such as the type of fiberboard.

What is claimed is:

1. A fiberboard splice apparatus comprising:
a fiberboard splice part for adhering an old fiberboard fed from one roll fiberboard to an end portion of a new fiberboard fed from the other roll fiberboard to accomplish fiberboard splice therebetween; and
a fiberboard feed device located between said fiberboard splice part and the other roll fiberboard for forwarding said new fiberboard to said fiberboard splice part;
said fiberboard feed device including
a fiberboard feed roll placed along an axial direction of the other roll fiberboard for rotating the other roll fiberboard while coming into contact with a surface of the other roll fiberboard;
a pickup member for picking up an end portion of the other roll fiberboard while coming into sliding contact with a surface of the other roll fiberboard; and
a guide member for guiding the end portion of the other roll fiberboard picked up by said pickup member to said fiberboard splice part.

2. A fiberboard splice apparatus according to claim 1, wherein said fiberboard feed device includes:
a pair of fiberboard feed rolls serving as said fiberboard feed roll;
a pair of pickup members serving as said pickup member;
a pair of roll supporting frames for supporting said pair of fiberboard feed rolls at their end portions;
a bar-like member placed along axial directions of said pair of fiberboard feed rolls to stretch between said pair of roll supporting frames; and
a pickup member supporting member attached to said bar-like member for supporting said pair of pickup members so that said pair of pickup members are in opposed relation to said pair of fiberboard feed rolls, respectively;
if the other roll fiberboard is in a face-winding condition in which a fiberboard is formed in a state where its fiberboard face constitutes an outer surface,
said bar-like member being rotated to bring a surface of one fiberboard feed roll and a tip portion of one pickup member into contact with a surface of the other roll fiberboard, while;
if the other roll fiberboard is in a back-winding condition in which a fiberboard is wound in a state where its fiberboard back constitutes an outer surface,
said bar-like member being rotated to bring a surface of the other fiberboard feed roll and a tip portion of the other pickup member into contact with a surface of the other roll fiberboard.

3. A fiberboard splice apparatus according to claim 1, wherein said fiberboard feed device includes:
a pair of fiberboard feed rolls serving as said fiberboard feed roll;
a pair of pickup members serving as said pickup member;
a movable guide member serving as said guide member, with said movable guide member being made to be touchable and separable on and from a surface of the one fiberboard feed roll;
a pair of roll supporting frames for supporting said pair of fiberboard feed rolls at their end portions;
a bar-like member located along axial directions of said pair of fiberboard feed rolls to stretch between said pair of roll supporting frames; and
a pickup member supporting member attached to said bar-like member for supporting said pair of pickup members so that said pair of pickup members are in opposed relation to said pair of fiberboard feed rolls, respectively;
if said bar-like member is rotated so that said fiberboard feed device takes a first position at which the other fiberboard feed roll and the one pickup member are touchable on a surface of the other roll fiberboard,
said movable guide member being placed at a position separated from a surface of the one fiberboard feed roll, and said new fiberboard being guided through a fiberboard feed passage extending from a portion between the one pickup member and the other fiberboard feed roll to said fiberboard splice part along said guide member, while;
if said bar-like member is rotated so that said fiberboard feed device takes a second position at which the one fiberboard feed roll and the other pickup member are touchable on a surface of the other roll fiberboard,
said movable guide member being moved in a direction of approaching a surface of the one fiberboard feed roll to hold an end portion of said new fiberboard led through a space between the other pickup member and the one fiberboard feed roll, and in this state, said bar-like member being rotated to shift said fiberboard feed device to said first position and said new fiberboard being guided through said fiberboard feed passage.

4. A fiberboard splice apparatus according to claim 1, wherein a tip portion of the other roll fiberboard is adhered onto an outer surface of the other roll fiberboard through the use of a tape, and said fiberboard splice apparatus further comprises:
a tape detection sensor for sensing the presence of the tape;
a fiberboard feed roll actuator for rotating said fiberboard feed roll; and
control means for issuing a control signal to operate said fiberboard feed roll actuator;
said control means being operative to render said fiberboard feed roll actuator to set a rotating speed of said fiberboard feed roll at a value below a predetermined rotating speed when said tape detection sensor senses the presence of said tape.

5. A fiberboard splice apparatus according to claim 1, wherein a tip portion of the other roll fiberboard is adhered onto an outer surface of the other roll fiberboard through the use of a tape and said pickup member is a finger having a function to cut said tape, and said fiberboard splice apparatus further comprises:
a fiberboard detection sensor for sensing the other roll fiberboard picked up by said finger;
a finger actuator for shifting said finger in an axial direction of the other roll fiberboard;
a fiberboard feed roll actuator for rotating said fiberboard feed roll; and
control means for outputting a control signal for operating each of said finger actuator and said fiberboard feed roll actuator;
when said fiberboard detection sensor senses the other roll fiberboard,
said control means being operative to output a signal to said fiberboard feed roll actuator for stopping the rotation of said fiberboard feed roll and further being operative to output a signal to said finger actuator to shift said finger in the axial direction of the other roll fiberboard for cutting said tape.

6. A fiberboard splice apparatus according to claim 1, wherein a tip portion of the other roll fiberboard is adhered onto an outer surface of the other roll fiberboard through the use of a tape and said pickup member is a peeling nail having a function to peel said tape, and said fiberboard splice apparatus further comprises:
a fiberboard detection sensor for sensing the other roll fiberboard picked up by said peeling nail;
a peeling nail actuator for shifting said peeling nail in an axial direction of the other roll fiberboard;
a fiberboard feed roll actuator for rotating said fiberboard feed roll; and
control means for outputting a control signal to operate each of said peel nail actuator and said fiberboard feed roll actuator;
when said fiberboard detection sensor senses the other roll fiberboard,
said control means being operative to output a signal to said fiberboard feed roll actuator for stopping the rotation of said fiberboard feed roll and further being operative to output a signal to said peel nail actuator for shifting said peel nail to under said tape, and even being operative to output a signal to said fiberboard feed roll actuator for rotating said fiberboard feed roll in the reverse direction to peel said tape in a state where said peel nail is positioned under said tape.

7. A fiberboard splice apparatus according to claim 1, further comprising a fiberboard end processing device for cutting said new fiberboard, fed by said fiberboard feed device, at a predetermined length from its tip portion.

8. A fiberboard splice apparatus according to claim 1, further comprising a tape adhering device for adhering a pressure sensitive adhesive double coated tape onto an end portion of said new fiberboard.

9. A fiberboard splice apparatus comprising:
a fiberboard splice unit having a fiberboard splice part for adhering an old fiberboard fed from one roll fiberboard to an end portion of a new fiberboard fed from the other roll fiberboard to accomplish fiberboard splice therebetween and a fiberboard feed device, which is located between said fiberboard splice part and the other roll fiberboard, for feeding said new fiberboard into said fiberboard splice part;
a roll stand equipped with an arm for supporting the other roll fiberboard; and
a fiberboard splice unit moving device for moving said fiberboard splice unit to a position facing the other roll fiberboard supported by said arm;
said fiberboard splice unit moving device being operative to adjust a position of said fiberboard splice unit in accordance with an arm angle of said roll stand.

10. A corrugate machine comprising a fiberboard splice apparatus stated in claim 1.

11. A fiberboard splice method of adhering an old fiberboard fed from one roll fiberboard to an end portion of a new fiberboard fed from the other roll fiberboard for accomplishing fiberboard splice therebetween, said method comprising the steps of:
rotating the other roll fiberboard by a fiberboard feed roll located along an axial direction of the other roll fiberboard and brought into contact with a surface of the other roll fiberboard;
picking up an end portion of the other roll fiberboard through the use of a pickup member brought into sliding contact with a surface of the other roll fiberboard; and
guiding, through the use of a guide member the end portion of the other roll fiberboard, picked up by said pickup member, to a fiberboard splice part in which the end portion of said new fiberboard is adhered onto said old fiberboard for the fiberboard splice.

12. A fiberboard splice method according to claim 11, wherein a pair of fiberboard feed rolls are provided as the fiberboard feed roll and a pair of pickup members are provided as the pickup member, and said method further uses a pair of roll supporting frames for supporting said pair of fiberboard feed rolls at their end portions, a bar-like member placed along axial directions of said pair of fiberboard feed rolls to stretch between said pair of roll supporting frames, and a pickup member supporting member attached to said bar-like member for supporting said pair of pickup members so that said pair of pickup members are in opposed relation to said pair of fiberboard feed rolls, respectively, and said method further comprises the step of:
if the other roll fiberboard is in a face-winding condition in which a fiberboard is wound in a state where its fiberboard face constitutes an outer surface,
rotating said bar-like member for bringing a surface of one fiberboard feed roll and a tip portion of one pickup member into contact with a surface of the other roll fiberboard; while,
if the other roll fiberboard is in a back-winding condition in which a fiberboard is wound in a state where its fiberboard back constitutes an outer surface,
rotating said bar-like member for bringing a surface of the other fiberboard feed roll and a tip portion of the other pickup member into contact with a surface of the roll fiberboard.

13. A fiberboard splice method according to claim 11, wherein a pair of fiberboard feed rolls are provided as said fiberboard feed roll, a pair of pickup members are provided as said pickup member and a movable guide member touchable and separable on and from a surface of the one fiberboard feed roll is provided as said guide member, and said method further uses a pair of roll supporting frames for supporting said pair of fiberboard feed rolls at their end portions, a bar-like member located along axial directions of said pair of fiberboard feed rolls to stretch between said pair of roll supporting frames, and a pickup member supporting member attached to said bar-like member to support said pair of pickup members so that said pair of pickup members are in opposed relation to said pair of fiberboard feed rolls, respectively, and said method further comprises the step of:
if said bar-like member is rotated so that taken is a first position at which the other fiberboard feed roll and the one pickup member are touchable on a surface of the other roll fiberboard,
placing said movable guide member at a position separated from a surface of the one fiberboard feed roll for guiding said new fiberboard through a fiberboard feed passage, extending from a portion between the one pickup member and the other fiberboard feed roll, to said fiberboard splice part along said movable guide member, while,
if said bar-like member is rotated so that taken is a second position at which the one fiberboard feed roll and the other pickup member are touchable on a surface of the other roll fiberboard,
moving said movable guide member in a direction of approaching a surface of the one fiberboard feed roll for holding an end portion of said new fiberboard led through a space between the other pickup member and the one fiberboard feed roll, and in this state, rotating said bar-like member so that said first position is taken to guide said new fiberboard through said fiberboard feed passage.

14. A fiberboard splice method according to claim 11, further comprising the step of, in a case in which a tip portion of the other roll fiberboard is adhered onto an outer surface of the other roll fiberboard through the use of a tape, when the presence of said tape is sensed by a tape detection sensor, driving a fiberboard feed roll actuator in accordance with a signal from control means to set a rotating speed of said fiberboard feed roll at a value below a predetermined rotating speed.

15. A fiberboard splice method according to claim 11, wherein a tip portion of the other roll fiberboard is adhered onto an outer surface of the other roll fiberboard through the use of a tape and said pickup member is a finger having a function to cut said tape, and said method further comprises the steps of, when the other roll fiberboard picked up by said finger is sensed by a fiberboard detection sensor, driving a fiberboard feed roll actuator in accordance with a signal from control means for stopping the rotation of said fiberboard feed roll, and driving a finger actuator in accordance with a signal from said control means for shifting said finger in an axial direction of the other roll fiberboard to cut said tape.

16. A fiberboard splice method according to claim 11, wherein a tip portion of the other roll fiberboard is adhered onto an outer surface of the other roll fiberboard through the use of a tape and said pickup member is a peeling nail having a function to peel said tape, and said method further comprises the steps of, when the other roll fiberboard picked up by said peeling nail is sensed by a fiberboard detection sensor, driving a peeling nail actuator in accordance with a signal from control means for stopping the rotation of said fiberboard feed roll, and driving a peeling nail actuator in accordance with a signal from said control means for shifting said peeling nail in an axial direction of the other roll fiberboard to peeling said tape.

17. A fiberboard splice method according to claim 11, wherein said new fiberboard fed from the other roll fiberboard is cut at a predetermined length from its tip portion.

18. A fiberboard splice method according to claim 11, wherein a pressure sensitive adhesive double coated tape is adhered onto an end portion of said new fiberboard.

19. A fiberboard splice method using, for fiberboard splice, a fiberboard splice part for adhering an old fiberboard fed from one roll fiberboard to an end portion of a new fiberboard fed from the other roll fiberboard supported by an arm of a roll stand and a fiberboard splice unit located between said fiberboard splice part and the other roll fiberboard and equipped with a fiberboard feed device for feeding said new fiberboard to said fiberboard splice part, said method comprising the step of moving said fiberboard splice unit on the basis of an arm angle of said roll stand so that said fiberboard splice unit is positioned at a position facing the other roll fiberboard.
